(19) United States
(12) Patent Application Publication
(10) Pub. No.: US 2025/0018728 A1
(43) Pub. Date: Jan. 16, 2025

(54) Recirculation system for ink or other material in a printing apparatus, in particular inkjet, and apparatus comprising said recirculation system

(71) Applicant: CEFLA SOCIETÀ COOPERATIVA, Imola (BO) (IT)

(72) Inventors: Luca Ferrari, Imola (BO) (IT); Francesco Ancarani, Imola (BO) (IT); Massimo Dovadola, Imola (BO) (IT)

(21) Appl. No.: 18/771,896

(22) Filed: Jul. 12, 2024

(30) Foreign Application Priority Data
Jul. 14, 2023 (IT) 102023000014841

(51) Int. Cl. B41J 2/185; B41J 2/175

(52) U.S. Cl. CPC B41J 2/185; B41J 2/17596

(57) ABSTRACT

A recirculation system for ink or other material, fed to a printing head, in particular of the inkjet type, includes a recirculation container associated with a printing head and translatable along a predefined printing stroke together with the printing head. The recirculation container has, in its interior, anti-sloshing devices of the ink or other material.

### FIELD OF THE INVENTION

The present invention relates to a system for recirculating ink, or the like, for printing equipment, in particular inkjet and an equipment comprising said recirculating system.

The present invention refers to the technical field of machines for printing on supports of various kinds, such as paper, cardboard, textile materials, metal materials, wooden materials, plastic materials, minerals or the like.

### BACKGROUND OF THE INVENTION

Equipment is known in the art, which comprises at least one tank for a printing material, such as paint, ink, or other types of enhancing materials. In particular, printing equipment is known which have a plurality of tanks, each dedicated to a distinct color, varnish or enhancing material.

The printing material, taken from the tank, is brought to a recirculation unit, which has the function of circulating the printing material through a printing head. In the prior art it is known that the recirculation of the printing material is necessary due to the tendency of the various printing materials to deposit and/or sediment, becoming unusable for printing and forcing a machine stop for cleaning operations and replenishment of new printing material.

Patent application EP2875956A1 by the same applicant describes a printing equipment comprising a printing head for printing a printing material on a support, and a recirculation unit. The recirculation unit comprises a first container, a second container, a first recirculation device for generating a first flow of said printing material from said first container towards said printing head and second container, and a second recirculation device for transferring the printing material from the second container to the first container. In particular, the first container of the printing material is maintained at a first negative pressure, i.e. lower than atmospheric pressure, while the second container is maintained at a second negative pressure, i.e. lower than the pressure of the first container.

Patent application IT201600107827A1 also describes a printing equipment similar to that described in document EP2875956A1.

In printing equipment, the container or containers of the recirculation system of the ink, or the like, is assembled translatable, forward and backward, along a movement path of the printing head which allows the ink, or the like, to be dispensed for a predetermined width of the printing substrate.

This movement is also performed by the container or containers of the recirculation system and therefore the ink or other printing material is subjected to a continuous sloshing which causes a swaying of the surface (or free surface) of the ink or other printing material contained in the tank or tanks of the recirculation system.

Furthermore, the sloshing movement can cause the inclusion of air in the ink or a deterioration in the quality of the ink when it is made up of a mixture of different components or an emulsion.

In the state of the art as described in the aforementioned documents, there are no solutions that are intended to avoid this sloshing effect.

### SUMMARY OF THE INVENTION

The present invention therefore has the aim of realizing an ink recirculation system in printing equipment of the aforementioned type which allows the drawbacks present in the state of the art to be overcome.

According to a first embodiment, the present invention solves the aforementioned problem, thanks to the provision of an anti-sloshing element inside the recirculation container or containers.

In particular, the present invention solves the aforementioned problem with a recirculation system for ink, or the like, which has the combination of characteristics of the independent claim 1.

A further problem present in printing equipment, and in particular in ink recirculation systems, consists in the fact that the current containers have on the bottom areas of possible stagnation of the ink entering and exiting the container or containers of the recirculation system.

According to a further aspect of the present invention, an embodiment which can be provided alternatively or in combination with the embodiment previously described, provides that at least one or all of the containers of the recirculation system, i.e. the first and/or the second container, have a particular shape of the bottom area of the container or containers.

In a variant embodiment of this embodiment, at least one container or all of the containers of the recirculation system and, in particular, one or both of the first and second containers, comprise a discharge outlet on the bottom of the same, being said discharge outlet provided at the lowest point of a bottom of the corresponding container, said point being provided at a bowl-shaped or well-shaped extension of at least part of the bottom of said container, said bowl-shaped or well-shaped extension having a funnel shape converging towards the discharge outlet opening.

In particular, the slope of the shell walls of said bowl or of said funnel-shaped well is such that it has a vertical directional component, i.e. in a direction parallel to the axis of the outlet opening, which is predominant with respect to the perpendicular to it, i.e. horizontal.

Furthermore, by providing an eccentricity of the outlet hole, the directional component vertical or parallel to the axis of the outlet hole is further increased so that at least on one side the wall of said bowl or of said well, shaped as a funnel, is relatively slightly sloping with respect to the vertical direction.

A further aspect of the recirculation system and of the printing equipment according to the present invention provides for a configuration wherein the container and in particular the first and second containers are made in a single piece thanks to an Additive Manufacturing process.

When an anti-sloshing element is provided, thanks to the additive manufacturing process it is also possible to make the anti-sloshing elements one-piece with the containers.

As regards these anti-sloshing elements, it is possible to provide different configurations of the same.

In general, said anti-sloshing elements are made up of walls or structural elements having a predetermined extension and a predetermined shape, even different from each other and which are housed inside at least part of the internal chamber of the corresponding container and define impediments or brakes to the free flowing of the liquid material inside the container following the effect of the translation of the container itself together with the printing head.

Various possibilities that can be provided alternatively or in combination with each other can consist of combinations of fins having pre-established relative orientations with respect to each other and with respect to the boundary walls of the corresponding container. Instead of fins, grid elements can be provided having predetermined dimensions of the openings and of the ribs for delimiting the same.

In a preferred embodiment also from the functional point of view, the anti-sloshing elements consist of a plurality of bulkheads which extend at least for a part of the volume of said internal compartment of the corresponding container and which divide said internal compartment into a plurality of chambers, while said bulkheads or at least some of them are of such dimensions and shapes with respect to the walls of said at least one container so that the compartments delimited by them are mutually communicating in correspondence with at least one segment of one or more of the perimeter edges of said bulkheads. In combination or alternatively said bulkheads or at least some of them may also possibly have optional communication openings.

In a typical but non-limiting embodiment, said bulkheads are provided in the lower part of the corresponding container, optionally in the part substantially corresponding to the lower half of the corresponding container.

According to yet another feature which can be provided in any combination or sub-combination with one or more of the previous variants and/or embodiments, said bulkheads are provided interposed between two opposite side walls of the corresponding container and are fixed to each other and to said two opposite walls of the corresponding container by means of one or more transverse rods distributed along the extension of the faces of the same.

Said bulkheads, or at least part of them, are oriented with at least one of the two directions that define the plane spanned by the same in a direction transverse to a direction of movement of the corresponding container.

Furthermore, according to another feature that may be provided in combination with one or more of the preceding characteristics, said bulkheads are provided in a number greater than two, preferably three bulkheads, and divide the internal compartment of the corresponding container in which they are housed into a number of sub-compartments greater than three, preferably greater than four sub-compartments.

In an alternative embodiment, the number of bulkheads and said sub-compartments is such that said sub-compartments have a thickness in the direction of the distance between two adjacent bulkheads and/or the adjacent side wall of the container, which is approximately one decimal order of magnitude smaller than the greater extension in one direction of the two perpendicular directions that define the plane spanned by the bulkhead having a greater extension compared to the other bulkheads provided, or slightly less than said decimal order of magnitude.

In an alternative embodiment, said bulkheads extend all in a direction transverse to a direction of movement of the corresponding container, preferably perpendicular.

In an alternative embodiment that can be provided alternatively to the embodiment described above or also in combination with the same, the anti-sloshing elements can be constituted by at least one pair of opposing fins which depart respectively from the inner side of each of at least two opposite shell walls of the corresponding container and which are optionally provided with a plurality of through openings distributed along the surface extension of said fins.

According to a further optional feature of this embodiment, each pair of opposite fins can branch off for a certain length of the corresponding wall from which it starts.

Still according to a further embodiment, each pair of opposing fins has fins which end at a certain distance from each other, delimiting an intermediate slot with the inner edges of the same.

In a possible embodiment, said internal edges of the opposite fins are made not straight and/or not parallel and/or have recesses which define enlargements of said intermediate slot.

According to yet another possible feature, said fins, or at least one of them, are oriented sloping downwards towards its edge inside the container and facing towards the corresponding inside edge of the opposite fin.

When provided in combination with anti-sloshing elements constituted by a plurality of bulkheads that extend for at least part of the volume of said internal compartment of the corresponding container and that divide said internal compartment into a plurality of chambers according to one or more of the embodiments described and claimed in the present description and claims, said bulkheads terminate all below a certain level of the vertical extension of the corresponding container leaving free the remaining part of the internal volume of said container, while said fins according to one or more of the previous variants described and claimed in the present description and claims are positioned inside the container in said part of the volume left free by the bulkheads and above said level.

The advantages of the present invention appear evident from the previous description and will emerge more clearly from the following description of some embodiments illustrated in the attached drawings.

These advantages consist first of all in the fact of being able to avoid the drawbacks due to the sloshing that the ink present in the recirculation system and above all in the tanks undergoes.

Added to this advantage are the advantages relating to the provision of a bottom of the containers which is particularly suitable for avoiding stagnation and for guaranteeing a constant recirculation flow for the entire mass of ink.

This effect is synergistically added to the presence of the anti-sloshing elements, further removing the manipulation of the recirculated fluids, or of the ink or the like, which can determine its degeneration or lead to other types of drawbacks.

The realization by Additive Manufacturing allows the realization of the internal anti-sloshing elements without requiring complex, expensive and unreliable manufacturing processes. Furthermore, this production process allows to have a pair of containers of the recirculation system which are made in one piece and therefore which guarantee to the maximum extent the watertightness of the containers and excellent mechanical strength.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 shows a diagram of a supply and recirculation circuit for ink or other substances to be applied for printing which has a recirculation system made according to the present invention.

FIG. 2 shows a vertical cross section through a combination of two containers of a recirculation system according to the prior art.

FIG. 3 shows, in perspective and with various constructional parts not inherent to the invention having been omitted, the combination of a printing head with a recirculation system according to the present invention according to two alternative embodiments.

FIG. 4 shows a cross section along a vertical plane transverse to the two containers, of a combination of a first and a second container of a recirculation system according to a first embodiment of the present invention.

FIG. 5 shows a view in elevation and in the direction of an axis perpendicular to the cross-sectional plane according to FIG. 4, said plane coinciding with the axes of the discharge holes of the two containers.

FIG. 6 shows a perspective view of the one-piece body comprising the containers and the heat exchange chambers relating to the recirculation system according to the present invention.

FIG. 7 illustrates a constructional detail of the container combination of the recirculation system according to the present invention.

FIG. 8 illustrates yet another constructional detail of the container combination of the recirculation system according to the present invention.

FIGS. 9 and 10 respectively show a cross section and a perspective section of a variant embodiment of the container of the recirculation system according to the present invention which differs from that of the previous FIGS. 3 to 6 in that it is not provided a recovery circuit of the thermal energy generated by the electronic and/or electric units as indicated in FIG. 3.

FIGS. 11 and 12 are figures similar to FIGS. 9 and 10 of an alternative embodiment of the anti-sloshing elements with respect to those of the previous embodiments.

FIG. 13 shows a perspective view of the containers of the recycling system according to FIGS. 9 to 12.

FIG. 14 shows a further embodiment of the recycling system according to the present invention, wherein one or both containers according to FIG. 13, and more generally to containers without heat exchange chambers as in the embodiment of FIGS. 3 to 6, electric heaters are applied in thermal contact with the outer longitudinal side wall of the shell of said containers.

FIGS. 15 and 16 show a view on an end side of the containers according to FIG. 14 and a cross section of said containers wherein the anti-sloshing elements according to the embodiment of FIGS. 11 and 12 are visible.

### DETAILED DESCRIPTION OF EMBODIMENTS OF THE INVENTION

Detailed descriptions of embodiments of the invention are provided herein. It is to be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

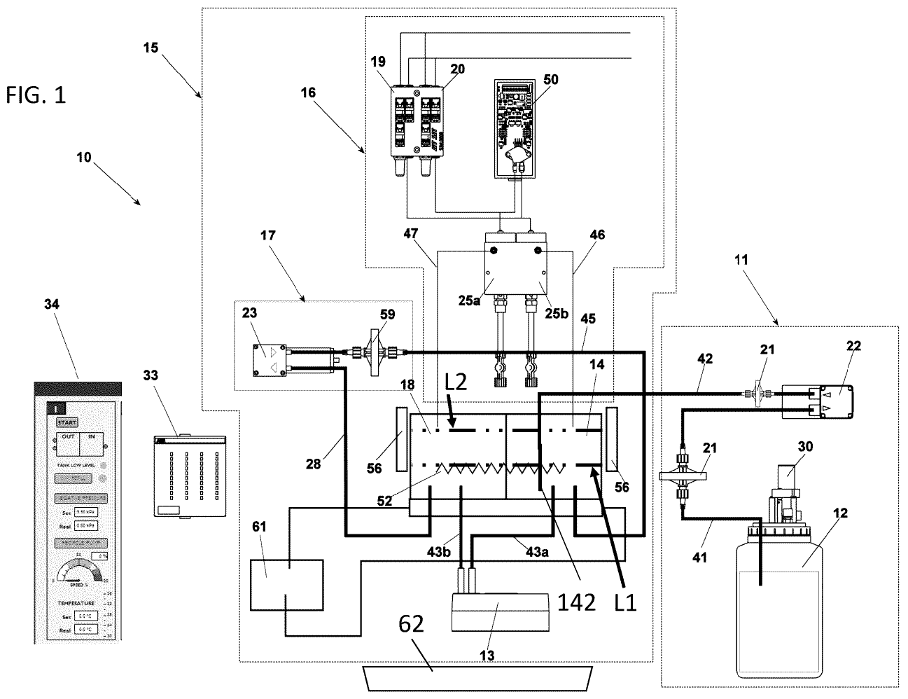

FIG. 1 shows a circuit diagram of a printing equipment which comprises an ink recirculation system of the type combinable with the features of the present invention.

According to the embodiment shown, the printing equipment 10 comprises a feeding device 11 which has the purpose of feeding the printing material, i.e. the ink or a varnish or other type of printing material towards a recirculation unit 15 which generates a continuous recirculation of the printing material in a printing head 13. Recirculation unit 15 for case of description is divided into two recirculation sub-units, a first sub-unit 16 and a second sub-unit 17.

The printing head 13 can be controlled in a known way to deposit the printing material, i.e. the ink, or the like, on the printing support (not shown in detail since it is not the subject of the present invention), according to a predetermined pattern.

According to a preferred embodiment, the feeding device 11 comprises an accumulation tank 12 wherein the printing material according to one or more of the embodiments defined above is contained, before being used for printing, and a first device for pumping 22 for transferring the printing material from the storage tank 12 to the recirculation unit 15. Tank 12 is connected to a filtering device 21 via a pipe 41. Pumping device 22 withdraws the ink from the storage tank 12 through a first suction pipe 41, and delivers it to the recirculation unit 15 through a second pipe 42.

In one embodiment, the feeding device 11 can furthermore comprise a mixing device 30 for periodically or continuously mixing the printing material contained in the accumulation tank 12.

A filtering device 21 can be interposed on the first pipe 41 and/or on the second pipe 42, for instance in the form of a filter or other similar devices.

According to the exemplary but non-limiting embodiment illustrated in FIG. 1, the recirculation system 15 comprises a first container 14 for the ink which is connected to the supply device 11. The first container 14 is connected to the accumulation tank 12 through pipe 42. The first container 14 is located upstream of a respective printing head 13 with which it is connected through a first pipe 43a. In a preferred embodiment, the first pipe 43a is connected to the lower area of the first container 14, so as to prevent the printing material contained in the first container 14 from incorporating air bubbles.

The recirculation system 15 further comprises a second container 18 for the printing material which comes from the printing head 13 via pipe 43b. In a preferred embodiment, the second pipe 43b is connected to the lower portion of the second container 18, so as to prevent the printing material contained in the second container 18 from incorporating air bubbles.

In one embodiment, the first container 14 and the second container 18 for the printing material lie on the same plane and can contain two distinct levels of printing material.

The recirculation system 15 of the exemplary embodiment illustrated is of the pneumatic type and comprises a pair of elements 19, 20 for the generation of negative pressure (in the form of a series of solenoid valves) connected to the first container 14 and to the second container 18 of the printing material. In particular, the elements 19, 20 for generating negative pressure are configured to induce a negative pressure, or vacuum, inside the first container 14 and the second container 18. The elements 19 and 20 operate in such a way as to generate a difference of negative pressure which is established between the first container 14 and the second container 18 and which induces the movement of the printing material from the first container 14 to the second container 18, passing through the printing head 13.

In one embodiment, the elements 19, 20 for generating negative pressure consist of a series of solenoid valves which are assembled on a mechanical block made to exploit the Venturi principle. In particular, the element 19 gives the negative pressure to the first container 14 and the element 20 gives the negative pressure to the second container 18; the two negative pressures are different between the two containers 14 and 18 of the printing material.

Typically, the negative pressure value inside the first container 14 for the printing material is equal to-4 kilopascals, while the value inside the second container 18 for the printing material is equal to-10 kilopascals. This pressure difference triggers the passage of the printing material from the first container 14 to the second container 18 passing through the printing head 13.

By acting on the two negative pressure generation elements 19 and 20, it is possible to vary the negative pressure inside the containers 14 and 18 of the printing material. Indicatively, the negative pressure values that can be achieved vary between 0 and-50 kilopascals.

Different printing heads and different printing materials require setting up the negative pressures in the first 14 and second 18 printing material containers.

The negative pressure values are detected by a pressure sensor 50 which detects the negative pressure values in the containers 14 and 18 of the printing material. The detected values are then sent to a control unit 33 which controls the elements 19 and 20 so as to obtain the desired negative pressure values.

Furthermore, the elements 19 and 20 have a further valve (not shown) which allows the cleaning of the printing head 13 with positive pressure, by changing the pressure inside the containers 14 and 18 of the printing material. Obviously, the cleaning cycle, which involves feeding the printing head 13 with positive pressure, is performed when the machine is not printing.

According to one embodiment, there are two overflow tanks 25a, 25b which are interposed between the first container 14 and the second container 18 of the printing material, for instance in an intermediate position along a first connecting pipe 46 and a second connecting pipe 47.

In particular, it is provided that in tank 25a, connected to the first container 14, the air is placed in a negative pressure condition, and also in tank 25b, connected to the second container 18, a condition of negative pressure is generated.

The tanks 25a, 25b can be provided with discharge valves, not shown in the drawings, of the condensate that may be generated, or of any printing material that may be present inside them. Furthermore, tanks 25a, 25b can be provided with sensors for detecting the printing material which, if activated, control or supply a signal for deactivating the elements 19, 20 for generating negative pressure. In this way it is possible to avoid damage to the negative pressure generation elements 19, 20.

In an embodiment of the present invention, the recirculation unit 15 also comprises a second recirculation sub-unit 17 for transferring the printing material from the second container 18 to the first container 14.

The second recirculation sub-unit 17 comprises a pumping device 23 connected, via a pipe 28, to the first container 14 and to the second container 18, to transfer the printing material from the second container 18 to the first container 14.

In a preferred embodiment, the suction pipe 28 is connected with one of its first ends to the lower portion of the second container 18. This embodiment prevents air from being sucked in through the suction pipe 28.

Pipe 28 connects the pumping device 23 to the second container 18 of the printing material, while a pipe 45 connects the pumping device 23 to the first tank 14 of the printing material. In a preferred embodiment, the pipe 45 is connected with one of its first ends to the lower portion of the first container 14. This embodiment prevents air from being sucked in through pipe 45.

In one embodiment, at least the delivery pipe 45 is provided with a filtering device 59 intended to filter the flow of printing material which is introduced from the second container 18 into the first container 14. Furthermore, the presence of the filtering device 59, in case of breakage of the membrane of the pumping device 23, prevents unwanted particles from ending up in the first container 14 of the printing material, and from there in the printing head 13 damaging it.

In one embodiment, detection devices 56 are provided which comprise a first level sensor for detecting the ink level in the first container 14, and a second level sensor for detecting the ink level in the second container 18.

The first level sensor and the second level sensor can be selected from a group comprising optical sensors, magnetic sensors, inductive sensors, capacitive sensors, floating elements, or possible combinations thereof.

In an embodiment, the recirculation system 15 comprises conditioning devices connected to at least one of the first 14 and the second 18 containers to modify the physical characteristics, for instance temperature and viscosity, of the printing material circulating through the printing head 13.

The conditioning devices can comprise a temperature regulation system, for instance made with a heat transfer circuit, capable of modulating the temperature of the ink contained in at least one of the first 14 and second 18 containers, for instance by heating and/or cooling action.

The conditioning devices comprise for instance a heating element 52 assembled externally to the first 14 and second 18 containers of the printing material to heat the printing material contained in the latter according to predefined methods.

The heating element 52 can be any type, for instance, but not limited to, an electric resistance as shown in FIG. 1, a thermo-conditioning circuit, or other device suitable for the purpose.

In a further embodiment, the conditioning devices comprise a cooling element 61 to induce in at least one of the first 14 and second 18 containers a cooling of the printing material contained therein and adjust its temperature to that of use by the printing head 13.

An example of a cooling element 61 can comprise a fluid-dynamic conditioning circuit which exploits the principles of a refrigeration cycle.

The printing equipment comprises a control unit 33, in particular a PLC, to monitor and manage at least the operating modes of the first recirculation sub-unit 16 and of the second recirculation sub-unit 17. In particular, the control unit 33, also as a function of the signals detected by the first level sensor and by the second level sensor, is capable of suitably managing the activation of the first pumping device 22 and of the pumping device 23 to maintain in the first container 14 and in the second container 18 a predetermined level of printing material in order to guarantee the correct supply to the printing head 13.

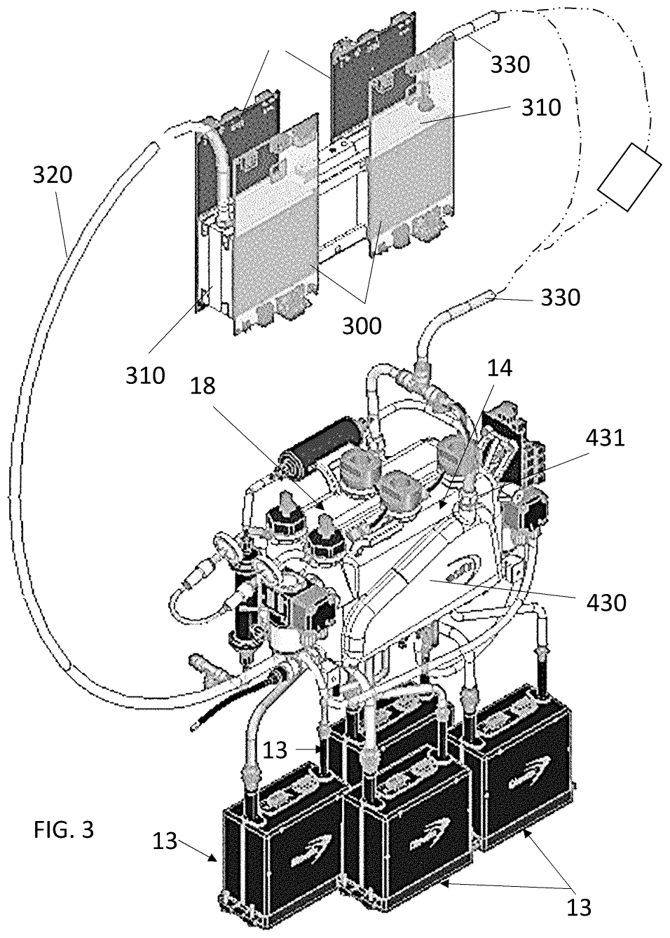

In one embodiment, the control unit 33 is connected with the components of the equipment 10 to be controlled and managed through electrical connections, such as electrical cables or electrical tracks (not shown), in case the control device comprises integrated boards, or PCB 300 (see for instance FIG. 3).

According to a further embodiment, the control unit 33 can be made dependent on interface devices 34 with a human user to allow the latter to selectively set some parameters relating to the recirculation of the printing material and monitor alarms and anomalies.

According to a variant embodiment, the interface devices 34 can be external to the printing equipment 10, for instance made using an electronic computer, such as a PC, or similar device.

Even if the present invention has been described with reference to a printing equipment 10 comprising a single printing head 13, it is evident that the same recirculation device can be applied to a printing equipment comprising several printing heads 13 as shown in FIG. 3.

In an embodiment, as shown in FIG. 3, the recirculation system 15 is also capable of feeding a greater number of printing heads, typically up to four.

However, embodiments are also possible wherein each printing head 13 has its own recirculation system 15 similar to what was described above.

Typically, in printing equipment of the aforementioned type, the printing heads 13 and also at least part of the corresponding recirculation system 15, in particular the first and second containers 14, 18 are assembled on a slide or a trolley and are translatable along a guide, forwards and backwards, between two extreme positions. In this way the printing head or heads 13 can cover relatively large dimensions of printing media. Generally, the translation direction is perpendicular to a feeding direction of the substrate.

FIG. 3 shows an embodiment wherein the two containers 14 and 18 of the recirculation system 15 feed four printing heads 13. Furthermore, the two containers 14 and 18 are integrated into a single one-piece body.

FIG. 3 also shows an exemplary embodiment of the control unit 33 or at least part of it which is distributed on various electronic boards, for instance PCBs which are indicated with 300.

According to one embodiment, the boards 300 are provided in combination with a system for cooling them consisting of one or more heat exchangers 310 which are in thermal contact with the boards themselves and which transfer the thermal energy from the boards to a heating or pre-heating fluid which is fed through ducts 320 to heat exchange chambers 430, 440 which are in thermal contact with the containers 14, 18.

Preferably the supply circuit of the heating fluid to the heat exchange compartments 430, 440 associated with the containers 14 and 18 is of the type capable of allowing said heating fluid to recirculate between said heat exchange compartments 430, 440 and the exchangers 310. The heat exchange compartments 430, 440 can consist of a single chamber which surrounds at least part of the outer wall of the containers 14 and 18, or they can be compartments completely separated from each other or communicating through communication passages.

Furthermore, some heat exchange compartments can be further connected to a cooling fluid supply circuit.

As previously described, the containers 14 and 18 of the recirculation system 15 follow the reciprocating movement and the ink contained therein is subject to sudden decelerations and accelerations which involve a sloshing of the ink in said containers, with the consequent swaying of the surface of the ink mass and with potential degeneration dangers of the ink due to possible air inclusions and/or even mechanical effects on the material mixtures that make up the inks themselves.

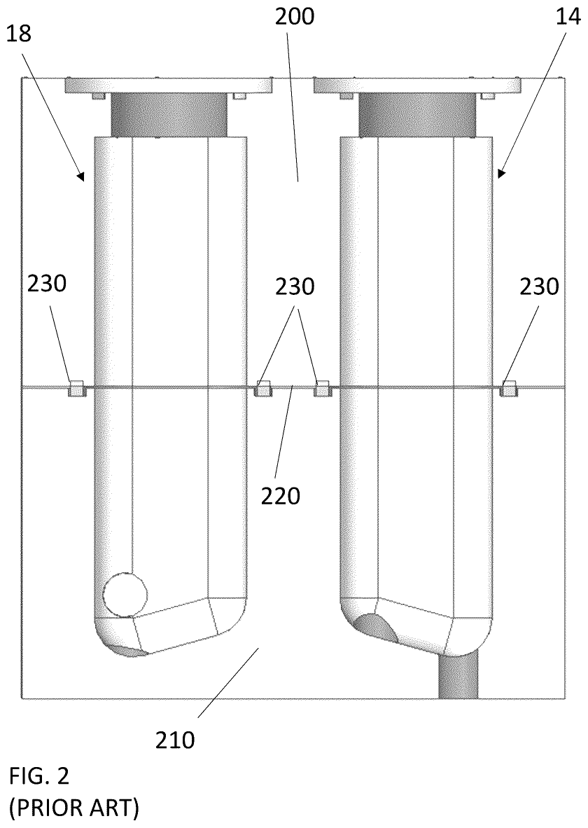

The production of the containers 14 and 18 of the recirculation system, used in systems according to the state of the art, is shown in FIG. 2. In the state of the art, the two containers 14 and 18 are formed by two half-shells separated from each other indicated as 200 and 210 and which can be tightly fixed together with the interposition of a gasket 220 by tightening the screw 230.

FIG. 2 shows an embodiment, wherein the chambers of the two half-shells are obtained by chip removal in a solid piece.

In addition to presenting a relatively high complexity and relatively high cost, this embodiment has the drawback of the tightly fixing of the two half-shells which is not only subject, in any case, to degradation over time also in view of the thermal stress but can lead to errors and therefore leaks already in the production step.

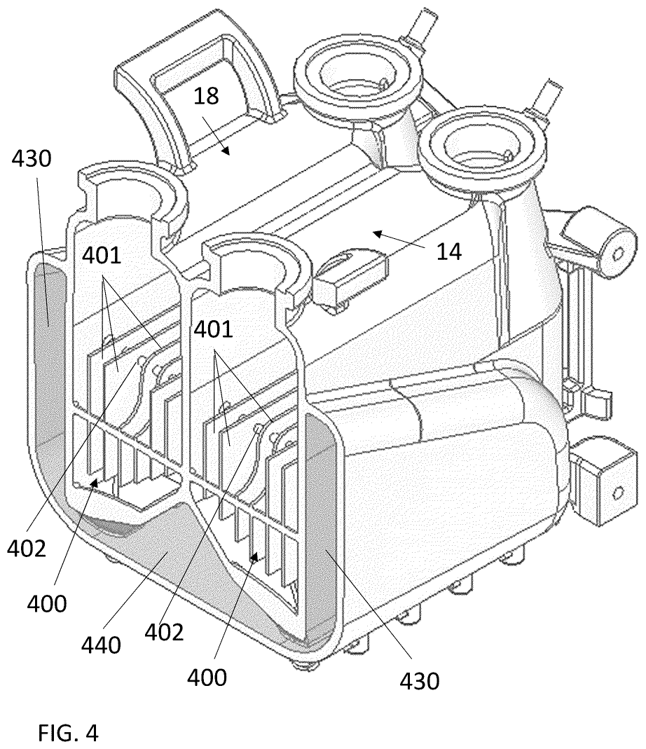

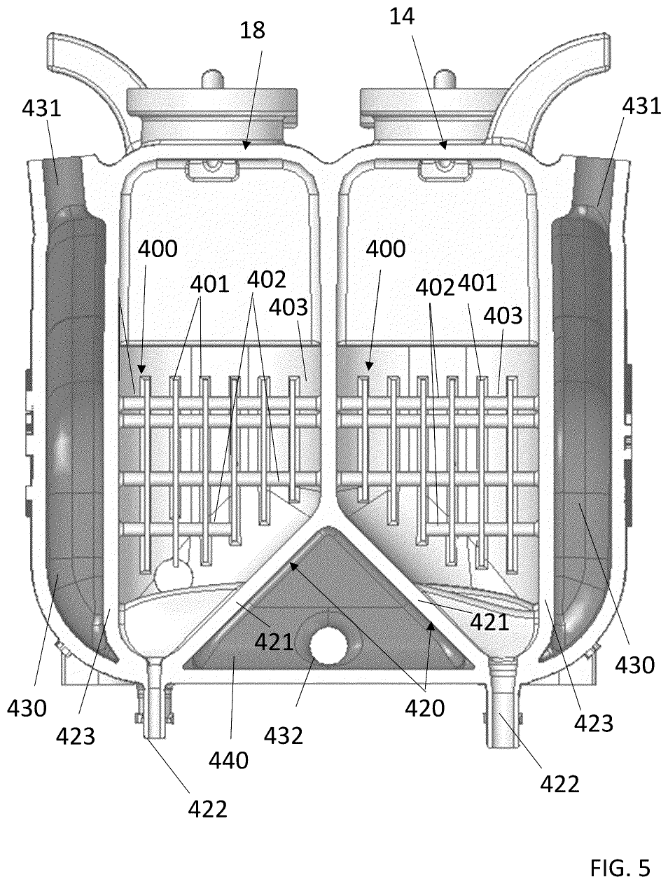

According to the present invention and as shown in FIGS. 4 and 5, the two containers 14 and 18 of the recirculation system 15 are made in one piece and of the same material. Said single body therefore makes it possible to overcome the problems of deterioration in the tightening of the containers.

The production technique called Additive Manufacturing was found to be advantageous for this production.

Thanks to this technology, as shown in FIGS. 4 and 5, it has not only been possible to make the pair of containers 14 and 18 in a single piece body, but it has also been possible to integrate in the compartment of said containers 14 and 18 an anti-sloshing element which prevents these waving movements of the ink during the movement of the containers 14 and 18 together with the printing head or heads 13.

The anti-sloshing elements indicated with 400 in FIGS. 4 and 5 can be made according to different configurations and generally comprise structural elements, such as walls, rods, fins, ribs or other which constitute obstacles to the free flow of the ink from one to the opposite wall of the containers due to the inertia of the fluid motion and the reciprocating movement of the containers themselves.

In particular, and without this constituting a limitation, but only by way of example, the containers according to the present example are intended to perform reciprocating translational movements in the transversal direction to the side walls of the same, or in a parallel or substantially parallel direction, at the sectional plane of FIGS. 4 and 5.

The illustrated non-limiting embodiment provides that said anti-sloshing elements consist of a plurality of bulkheads 401 which extend predominantly transversely to the translation direction of the containers 14, 18.

According to the illustrated embodiment, the bulkheads can be parallel to each other and laterally equidistant, the distance being mainly defined by the number of bulkheads 401 provided.

The bulkheads 401 are held in position between crosspieces 402 in the form of rods transverse to the surface extension of the bulkheads themselves.

Advantageously and preferably, the compartments 403 into which the chamber or part of the chamber of the containers 14, 18 is divided communicate with each other.

Communication between compartments can take place due to different configurations of the bulkheads which can also comprise through windows, from side to side, distributed along their surface extension.

In the illustrated embodiment, the compartments 403 formed by the bulkheads 401 are open at least along one of the perimeter edges of the bulkheads themselves, for instance at least along the lower and upper edges of the bulkheads 401.

According to one embodiment, the anti-sloshing elements 400 are provided only in some areas of the chambers of containers 14, 18, in particular approximately in the lower half of said containers 14, 18.

In the illustrated embodiment, communication between the compartments 403 delimited by the bulkheads 401 takes place because said bulkheads end with at least part of their peripheral edges at a certain distance from the wall of the container 14, 18, thus defining passages between compartment and compartment 403.

Still according to an embodiment, the bulkheads 401 are arranged substantially vertically and divide the chamber into compartments 403 interposed between the two opposite side walls of the containers, between which the crosspieces 402 extend.

Furthermore, according to another feature that can be provided in combination with one or more of the preceding features and which is shown in the figures, said bulkheads are provided in a number greater than two, preferably three bulkheads, and divide the internal compartment of the corresponding container in which they are housed into a number of sub-compartments greater than three, preferably greater than four sub-compartments, with the number of bulkheads optionally being such that the sub-compartments have a width between two adjacent bulkheads that is at least one decimal order of magnitude smaller than the extension of said bulkhead in one direction of the two directions that define the plane defined by said bulkheads.

FIGS. 4, 5, and 9, 10 show a number of bulkheads equal to 6 that divide the internal compartment between two side walls of the corresponding container into seven sub-compartments. These compartments have a thickness in the direction of the distance between two adjacent bulkheads and/or a side wall that is approximately one decimal order of magnitude smaller than the greater extension in one direction of the extension of the plane spanned by the bulkheads having a greater extension or slightly smaller than said decimal order of magnitude.

As is evident from FIGS. 4 and 5, a further characteristic of the containers 14 and 18 of the recirculation system according to the present invention provides that the bottom of the containers 14 and 18 is made in the form of an extension 420 in the shape of a bowl or well which is configured as a funnel.

For at least one sector 421 of the converging shell side walls of said funnel shape of the bowl or well 420, the slope of said shell wall 421 is relatively steep, i.e. it has a preponderant directional component which is oriented parallel to the vertical direction or to the axis of a discharge opening 422.

The funnel shape of the bowl or well 420 according to a preferred, but non-limiting embodiment is asymmetrical, said discharge opening 422 being provided laterally offset in the direction of a side wall of the corresponding container 14, 18 and in detail, but not in limitation, of the shell wall of the corresponding outermost container 14, 18. In this way, at least one sector 423 of the shell wall of the funnel-shaped well or bowl 420 has a substantially vertical direction without deviating substantially from the extension direction of the shell wall of the container 14, 18, while at least the diametrically opposite sector 421, with reference to the discharge opening 422, is sloping with respect to the vertical direction towards the opposite sector 423.

With reference to a further characteristic, externally to at least a part of the boundary wall of the containers 14, 18 and preferably, but not in a limiting way externally to at least a part or all of the outermost side of the shell wall of said containers 14, 18, for each container 14, 18 is provided a chamber 430 for containing and optionally also for passage of a heating fluid.

Said chamber 430, i.e. the walls delimiting it, are made in one piece, i.e. they form a single body, with the walls of the containers 14, 18.

The cross-sectional plane of FIG. 5 shows the two heat exchange chambers 430 with a corresponding opening 431, for instance a heating fluid discharge opening, a further supply opening for said heating fluid being also provided, which is visible in FIG. 5 and is indicated with 432.

According to yet another feature, visible in the figures, in particular in FIGS. 4 and 5, it is possible to provide further heat exchange chambers, such as the one indicated with 440 and provided, but not in a limiting way, in an intermediate position between the two containers 14 and 18, and in particular between the two funnel-shaped bowl or well extensions of the bottom side thereof.

The additional heat exchange chamber can be used for the heat exchange of the containers, i.e. of the ink contained in them with a cooling fluid.

Alternatively, it is possible to modify the fluid supply circuit in such a way that only a heating fluid or a cooling fluid can be supplied to one or more of the heat exchange chambers or in such a way that depending on the conditioning functions at least some or all of the heat exchange chambers 430 and 440 are required to be alternatively supplied with a heating fluid or a cooling fluid.

Also this configuration of the heat exchange chambers is obtained advantageously thanks to a production process called Additive Manufacturing which allows to make all the walls of the containers and of the heat exchange chambers as well as the anti-sloshing devices as a one-piece body, i.e. as a single body.

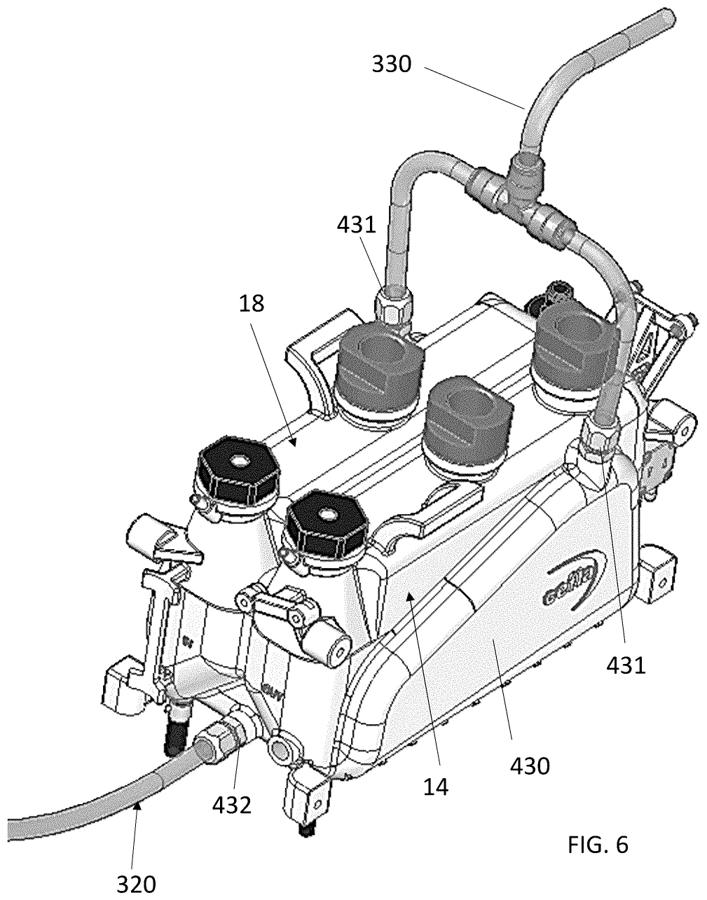

With reference to FIG. 6, in a preferred embodiment, the pair of containers 14 and 18 of the recirculation system is in the form of a single body C as already indicated and described above, said body also comprising the walls delimiting the heat exchange chambers. According to this example, the two lateral heat exchange chambers 430 and the lower central one 440 communicate with each other, since the inlet of the heat exchange fluid, in particular for heating 432, is provided in the lower central chamber, while the heat exchange fluid in particular for heating is let out of each of the two lateral, external heat exchange chambers 430 by a corresponding outlet 431.

With reference to FIG. 3, the heat exchange fluid comes from heat exchangers 310 which are in thermal contact with one or more circuit boards of the control unit 33 or part thereof and which are intended for dissipating the heat produced by these boards. The outlets 431 of the heat exchange chambers 430 connect back to the heat exchangers 310 with a common return pipe 330.

Thanks to this configuration, the heat taken from the boards for their cooling is used to bring the ink to the desired working temperature or to preheat it to a temperature closer to the working one.

The aforementioned circuit comprising the heat exchange compartments 430, 440 in communication with heat exchangers 310 in thermal contact with one or more electric or electronic boards 300 of the printing device, can be implemented according to two embodiments provided in FIG. 3 and which can be provided alternatively or in combination with each other.

According to a first alternative, the heating fluid is circulated through the ducts 320 and 330 from the heat exchange chambers 430, 440 and the heat exchangers 310.

In an alternative embodiment, the thermal energy recovered from cooling the boards 300 constitutes only a part of the energy necessary for heating the ink in the containers 14 and 18 and the heating fluid is passed further into an additional heating system, preferably provided in series in the circuit of said fluid, said system being globally indicated with 340 in FIG. 3.

Further alternatives are possible which may provide that the heating fluid fed to the heat exchange chambers 430, 440 is heated to the working temperature exclusively thanks to the heating system 340, the heat exchangers 310, cooling boards 300, being therefore omitted, deactivated or not provided.

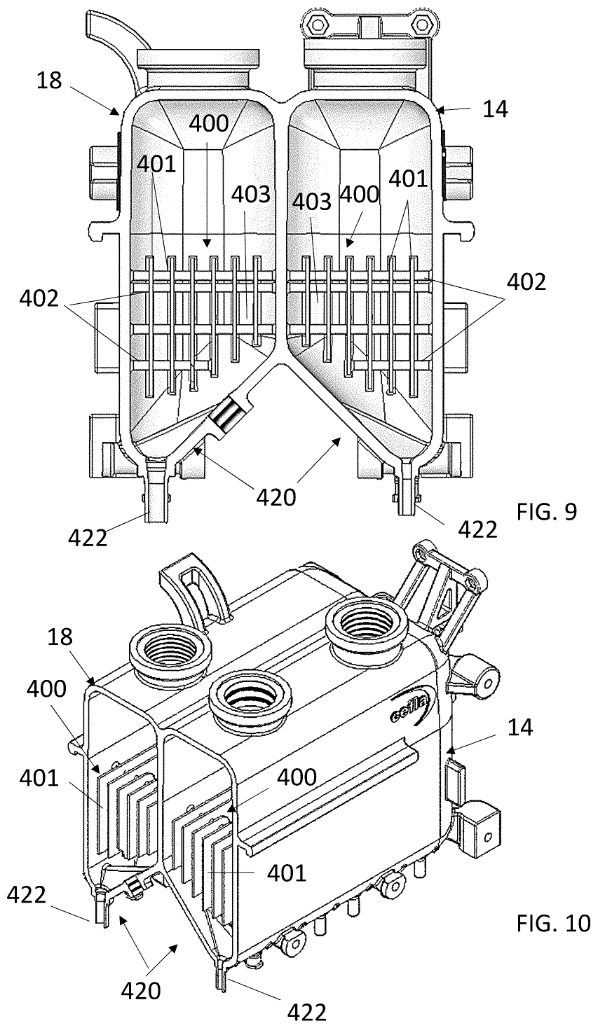

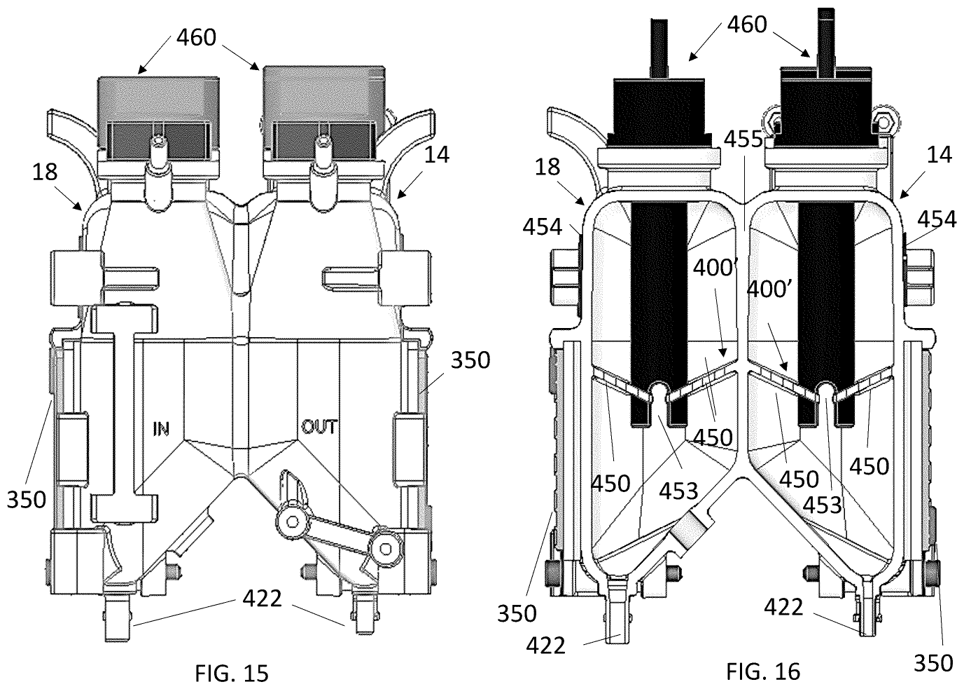

Still according to an embodiment which is illustrated with reference to FIGS. 9 to 16, the containers of the recirculation system can be without the heat exchange chambers 430, 440. In this case the heating of the ink can take place thanks to different heating elements.

This solution can optionally also be provided in combination with one or more of the embodiments previously described.

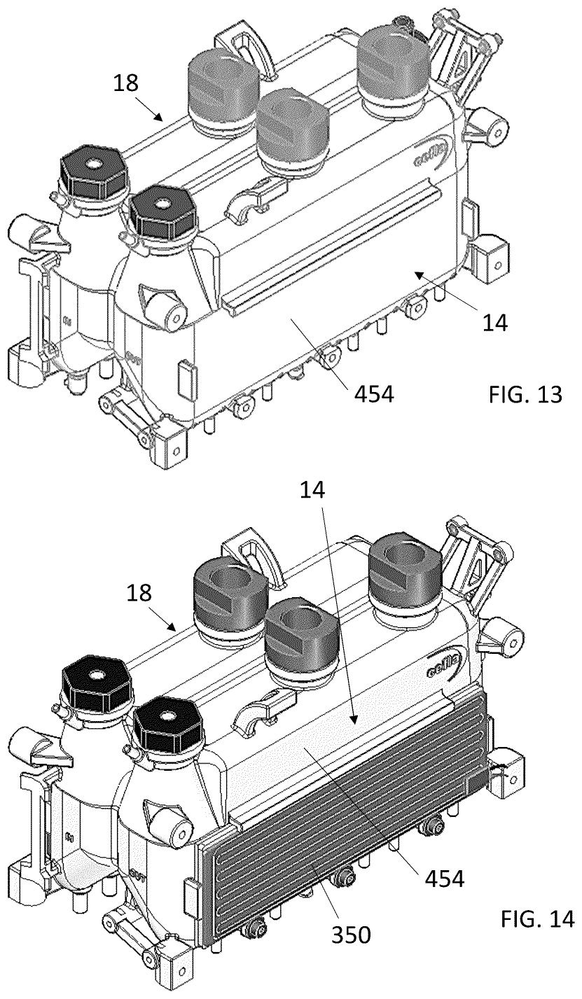

A variant embodiment illustrated in FIGS. 14 to 16 shows the containers 14, 18 of the recirculation system 15 which are in heat exchange with electric heaters applied to at least one of the outer shell walls of said containers. Said heaters are indicated with 350 in FIGS. 14 to 16.

With reference to the different variants of the anti-sloshing elements 400 shown in the various figures, it should be emphasized that, although said variants are illustrated with reference to specific examples relating to the different variants of the ink heating devices, it is possible to provide any combination of configuration of the anti-sloshing elements 400 with any configuration of the units or systems for heating and/or pre-heating and/or cooling of the ink associated with said containers 14 and 18.

With reference to the figures and in particular to FIGS. 9 and 10, these show a variant of the containers 14 and 18, wherein there are no chambers for the heating fluid as provided instead in the embodiment of FIGS. 4 and 5, while the anti-sloshing elements 400 are made in a way identical to those of the exemplary embodiment according to said FIGS. 4 and 5, as well as the bottom of the containers themselves, so that the description relating to FIGS. 4 and 5 also applies to that of FIGS. 9 and 10.

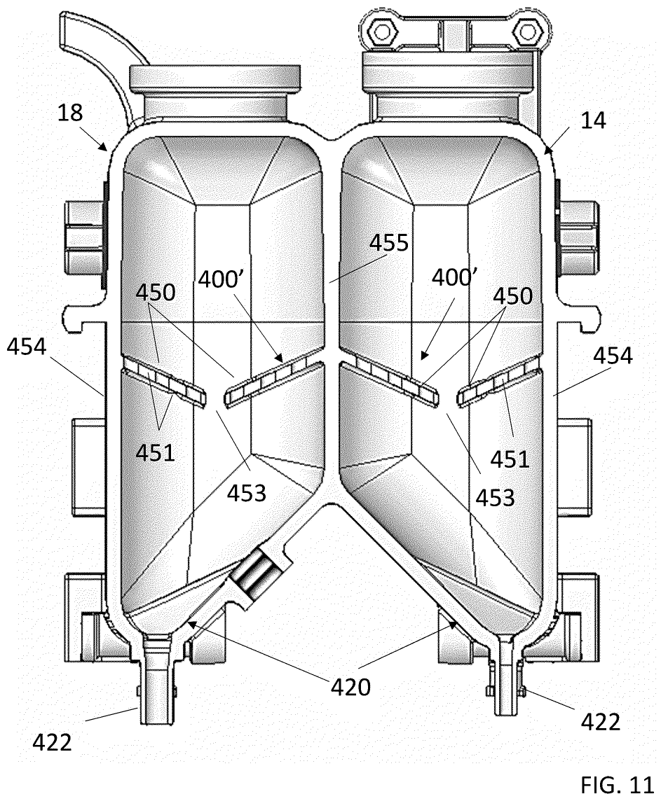

FIGS. 11 and 12 show a variant embodiment of the containers 14 and 18 in relation to the specific embodiment of the anti-sloshing elements which are indicated with 400′.

According to this embodiment, the anti-sloshing elements comprise two opposite fins 450 which depart from two opposite side walls of the shell 454, 455 of the corresponding container 14, 18. The fins are made with holes or grids, i.e. they have along their surface extension a plurality of openings 451 which are distributed according to a predetermined order and which have a predetermined size or whose size is foreseen within a predetermined dimensional range.

According to a further feature, said two fins 450 extend substantially along the entire length of the corresponding side wall 454, 455 or a succession of side-by-side fins are provided, each extending for a part of said length of said side walls.

According to yet another characteristic, the facing internal edges of the fins 450 delimit an intermediate slot 453 having a predetermined width.

When probes or sensors are provided, such as for instance ink temperature sensors or other types of sensors, indicated for instance with 460 in FIG. 16, the inner edges of one or both fins 450 can have one or more recesses which form enlargements 452 of said slot and which are of such dimensions as to allow the passage of said probes 460.

According to yet another possible characteristic and which is illustrated in the embodiment of the figures, the two fins are sloping downwards in the direction of their free inner edge.

In a preferred but non-limiting embodiment, the two fins are made symmetrical or essentially symmetrical with respect to the vertical median plane of the corresponding container 14, 18.

Despite the embodiments of the anti-sloshing elements according to FIGS. 4, 5, and 9, 10 and those according to FIGS. 11, 12, and 16 showing separately one or more adjacent bulkheads and two converging fins that delimit a central slot, these embodiments can also be provided in combination with each other, with the two converging fins 450 of FIGS. 11, 12, and 16 positioned at a certain distance above the upper edges of the bulkheads.

As in the version where the fins 450 are provided separately from the bulkheads, the length of the two fins can differ from each other, and therefore the intermediate slot formed by their inner edges can be eccentrically positioned relative to the central axis of the corresponding container. Optionally, the said slot can coincide with a sub-compartment delimited by two adjacent bulkheads, or the said slot can be provided in such a position that the upper edge of a bulkhead is aligned on a plane interposed between the edges of the said slot, that is, the inner edges of the two opposing fins.

In relation to the embodiments of FIGS. 11 and 12, it should also be noted that these relate to an embodiment of the containers without the heat exchange chambers like those of the embodiment of FIGS. 4 and 5. However, a variant embodiment can be foreseen wherein also the embodiment of FIGS. 11 and 12 can have one or more heat exchange chambers such as those provided in the embodiment of FIGS. 4 and 5 and indicated with 430 and 440. Obviously, the provision of these heat exchange chambers will be configured in a manner corresponding to the specific shape of the containers 14 and 18 according to FIGS. 11 and 12.

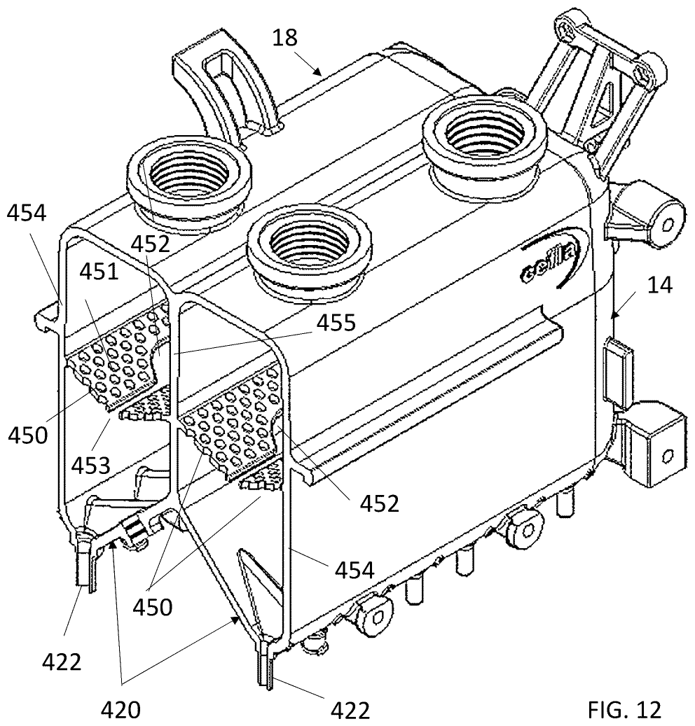

FIG. 13 shows a perspective view of the pair of containers 14, 18 made according to the embodiments of FIGS. 9 and 10 and 11 and 12 and without heat exchange chambers or ink heating elements in heat exchange with said containers.

With reference to FIGS. 14 to 16, they show a pair of containers 14 and 18 made essentially according to the embodiment of FIGS. 11 to 13, wherein said containers are provided coupled in thermal contact with heating units 350. They can be of any type, such as for instance electric heaters which are in thermal contact with the outer side wall 455 of the containers 14, 18 or at least with a part thereof.

In consideration and for completeness it must be considered that it is also possible to provide that said heaters extend only for part of the surface of the shell wall of the containers 14 and 18 or of only one of these and that instead on the remaining part of this shell wall, there are heat exchange chambers such as chambers 430 or 440 described in the previous embodiments and intended to be fed with a heating fluid coming from a heating system and/or from a heat recovery system taken when cooling the electronic boards and/or electrical devices of the printing device according to one or more of any variant described above.

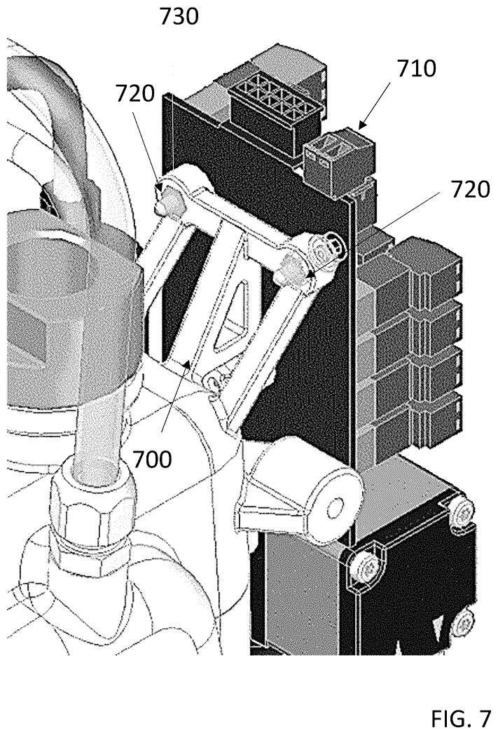

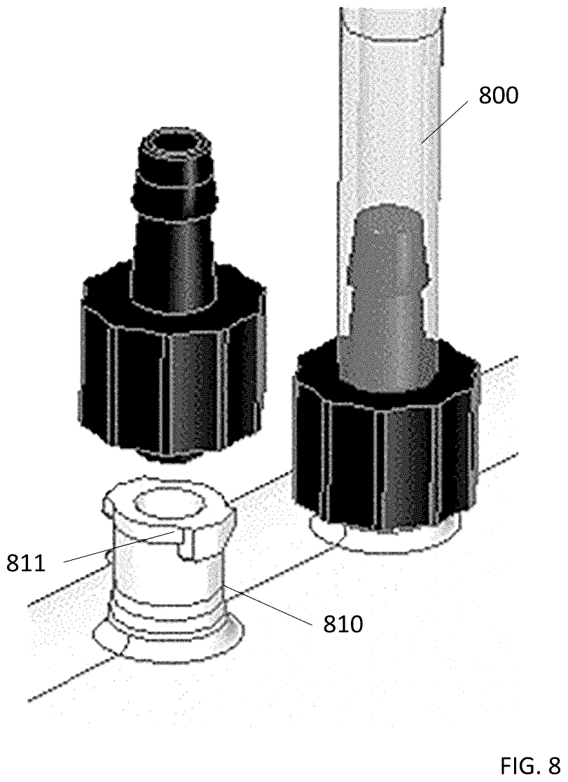

FIGS. 7 and 8 illustrate further configurations of the containers 14, 18 of the recirculation system 15 which can be obtained easily and with limited costs since they do not require post-processing by means of chip removal forming processes thanks to the additive manufacturing process.

In particular, the containers 14 and 18 have at least one, generally a plurality of brackets 700 for fixing additional parts, such as the board 710 which can already be made with the specific shape required, without the need for post-processing, and which specifically also have housings 720 of a shape corresponding to the nut screws 730 for tightening the fastening bolts of the board 710.

Similarly, a further feature of the containers 14 and 18 according to the present invention and which can be made at low costs by avoiding post-processing with chip removal forming processes, provides that, for instance for fixing the more rigid PE pipes 800 coming from the ink inlet and recirculation pumps, the corresponding pipe unions 810 on the containers 14, 18 have been shaped so as to reproduce the male Luer profiles 811 directly on the pipe unions during the manufacture of the containers 14, 18. This entails a strengthening of the connection and avoids the breakage of the tail piece when fixing the tube.

While the invention has been described in connection with the above-described embodiments, it is not intended to limit the scope of the invention to the particular forms set forth, but on the contrary, it is intended to cover such alternatives, modifications, and equivalents as may be included within the scope of the invention. Further, the scope of the present invention fully encompasses other embodiments that may become obvious to those skilled in the art and the scope of the present invention is limited only by the appended claims.

### LIST OF REFERENCE NUMBERS

10 printing equipment

11 feeding device

12 storage tank for the printing material

13 printing head

14 first container of the printing material

15 recirculation units

16 first recirculation sub-unit

17 second recirculation sub-unit

18 second container of the printing material

19 element for generating negative pressure

20 element for generating negative pressure

21 filter device

22 pumping device

23 pumping device

25a first overflow tank

25b second overflow tank

28 pipe

30 mixing device

33 control units

34 interface device

41 pipe

42 pipe

43a pipe

43b pipe

45 pipe

46 pipe

47 pipe

50 pressure sensor

52 heating element

56 detection devices

59 filter device

61 cooling element

200 half shell

210 half shell

220 gasket

230 screw tightening

300 control board electronic boards

310 heat exchanger

320, 330 ducts

340 heating system

350 electric heaters

400, 400′ anti-sloshing elements

401 bulkheads

402 stringer

403 compartments

420 funnel extension

421 shell wall sector

422 exhaust outlet

423 shell wall sector

430 Heat exchange chamber

431 heat exchange chamber outlets

423 feeding hole

440 heat exchange chamber

450 perforated or grid shaped fins

451 holes

452 probe passage enlargements

453 intermediate slot

454, 455 shell side walls

460 probes

700 brackets

710 electronic board

720 slots

730 lead screw

800 PE rigid pipe

810 pipe union

811 Luer attachment profile

The invention claimed is:

1. A system for recirculation of ink or other material, fed to a printing head, comprising:
one or more recirculation containers associated with a printing head and translatable along a predefined printing stroke together with the printing head; and
anti-sloshing devices of the ink or other material contained within the one or more recirculation containers,
wherein the one or more anti-sloshing devices comprise walls or structural elements having a predetermined extension and a predetermined shape, even different from each other, which are housed inside at least part of an internal chamber of the one or more containers and define impediments or brakes to a free flow of a liquid material inside the one or more containers following a translation of the one or more containers together with the printing head, and
wherein at least some of the anti-sloshing devices are made in one piece with walls of a corresponding container.

2. The system according to claim 1, wherein the one or more containers comprise:
a first container of the ink or other material connected to a supply circuit of the ink or other material and provided upstream of the printing head; and
a second container for of the ink or other material, connected downstream of the printing head (13);
the system further comprising:
a first recirculation sub-unit that generates a first flow of the ink or other material from the first container towards the printing head and the second container; and
a second recirculation sub-unit that transfers the ink or other material from the second container to the first container,
wherein the first and/or the second container comprise the one or more anti-sloshing devices.

3. The system according to claim 2, wherein the one or more anti-sloshing devices are configured as a plurality of bulkheads which extend for at least part of a volume within an interior the corresponding container and divide the interior into a plurality of chambers,
wherein the plurality of bulkheads or at least some bulkheads are of such dimensions and shapes with respect to the walls of the one or more containers so as to cause the plurality of chambers to be mutually communicating with at least a segment of one or more perimeter edges of the plurality of bulkheads, and
wherein the plurality of bulkheads or at least some of the bulkheads have communication openings.

4. The system according to claim 3, wherein the bulkheads are oriented vertically and are parallel to each other.

5. The system according to claim 3, wherein the bulkheads are provided in a lower part of the corresponding container.

6. The system according to claim 3, wherein the bulkheads are provided interposed between two opposite side walls of the corresponding container and are fixed to each other and to the two opposite walls of the corresponding container with one or more transverse rods distributed along an extension of sides of the bulkheads.

7. The system according to claim 1, wherein the anti-sloshing devices are constituted by at least one pair of opposing fins which are perforated or grid shaped and which depart respectively from one of at least two opposite walls of the corresponding container, the fins optionally ending in an intermediate area of the corresponding container at a distance from each other, forming an intermediate slot and having an orientation with a longitudinal portion that is horizontal or parallel to a bottom of the corresponding container.

8. The system according to claim 3, wherein the first and/or the second container comprises a discharge outlet on a bottom thereof, the discharge outlet being at a lowest point of a bottom of the first and/or the second container, the lowest point being located in correspondence with a bowl-shaped or well-shaped extension of at least part of the bottom of the first and/or the second container, the bowl-shaped or well-shaped extension having a funnel shape converging towards a corresponding opening of the discharge outlet.

9. The system according to claim 8, wherein the bowl-shaped or well-shaped extension is provided below lower end edges of the plurality of bulkheads.

10. A recirculation system for ink or other material, fed to a printing head, comprising:
a recirculation container associated with a printing head and translatable along a predefined printing stroke together with the printing head,
wherein the recirculation container comprises a discharge outlet on a bottom thereof, the discharge outlet being provided at a lowest point of a bottom of the recirculation container, the lowest point being provided in correspondence with a bowl or well extension of at least a portion of the bottom of the recirculation container, the bowl or well extension having a funnel shape converging toward an opening of the discharge outlet.

11. The recirculation system according to claim 10, further comprising:
the recirculation container associated with the printing head and translatable along a predefined printing stroke together with the printing head; and
anti-sloshing devices of the ink or other material contained within the one or more containers,
wherein the one or more anti-sloshing devices comprise walls or structural elements having a predetermined extension and a predetermined shape, even different from each other, which are housed inside at least part of an internal chamber of the one or more containers and define impediments or brakes to a free flow of a liquid material inside the one or more containers following a translation of the one or more containers together with the printing head, and
wherein at least some of the anti-sloshing devices are made in one piece with walls of a corresponding container.

12. A recirculation system for ink or other material, fed to a printing head, comprising:
a first container of the ink or other material, connected to a supply circuit and provided upstream of the printing head;
a second container for the ink or other material, connected downstream of the printing head;
a first recirculation sub-unit for generating a first flow of the ink or other material from the first container toward the printing head and the second container; and
a second recirculation sub-unit for transferring the ink or other material from the second container to the first container,
wherein the first container and the second container and optionally anti-sloshing devices provided in the first container and the second container are made in one piece with an additive manufacturing process.

13. The recirculation system according to claim 12, further comprising:
wherein the anti-sloshing devices comprise walls or structural elements having a predetermined extension and a predetermined shape, even different from each other, which are housed inside at least part of an internal chamber of the first container and/or the second container and define impediments or brakes to a free flow of a liquid material inside the first container and/or the second container following a translation of the first container and/or the second container together with the printing head, and
wherein at least some of the anti-sloshing devices are made in one piece with walls of the first container and/or the second container.

14. A printing apparatus on a printing material comprising:
the recirculation system according to claim 10;
the printing head for ejecting onto the printing material the ink or other material; and
a supply circuit to the printing head of the ink or other material,
wherein the supply circuit comprises a tank for containing the ink or other material, connected to the printing head through the recirculation system to generate a recirculation of the ink or other material through the printing head.
